(19) United States
(12) Patent Application Publication
(10) Pub. No.: US 2010/0144359 A1
(43) Pub. Date: Jun. 10, 2010

(54) APPARATUS AND METHOD FOR ALLOCATING IN WIRELESS COMMUNICATION SYSTEM

(75) Inventors: Yoo-Seung SONG, Daejeon (KR); Minho Cheong, Daejeon (KR); Jeeyon Choi, Daejeon (KR); Yun-Joo Kim, Gyeonggi-do (KR); Sun-Sim Chun, Daejeon (KR); Sok-kyu Lee, Daejeon (KR); Chang-Min Park, Daejeon (KR); Junghoon Jee, Daejeon (KR); Hong-Seok Jeon, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/632,223

(22) Filed: Dec. 7, 2009

(30) Foreign Application Priority Data
Dec. 9, 2008 (KR) 10-2008-0124631
Oct. 20, 2009 (KR) 10-2009-0099941

(51) Int. Cl. H04W 72/04

(52) U.S. Cl. 455/450

(57) ABSTRACT

An apparatus for allocating resources in a wireless communication system includes: a verification unit configured to receive channel information and base station information of a system, verify from the channel information the number of channels capable of being used in the system and bandwidths of the channels, and verify from the base station information the number of base stations and bandwidths of channels requested by the base stations to be allocated; an allocation unit configured to allocate at least one channel of the channels capable of being used to each base station in response to verification by the verification unit; and a generation unit configured to generate allocation information corresponding to channel allocation by the allocation unit and transmit the allocation information to the base stations.

### CROSS-REFERENCE(S) TO RELATED APPLICATIONS

The present application claims priority of Korean Patent Application No(s). 10-2008-0124631 and 10-2009-0099941, filed on Dec. 9, 2008, and Oct. 20, 2009, respectively, which are incorporated herein by reference in their entirety.

### BACKGROUND OF THE INVENTION

1. Field of the Invention

Exemplary embodiments of the present invention relate to a communication system, and more particularly, to an apparatus and a method for allocating resources which can improve data transmission efficiency by using a plurality of channels in a wireless local area network (WLAN) communication system.

2. Description of Related Art

Currently, in the field of wireless communication, research has actively been conducted to provide to users various services of high quality at a high speed. Specifically, research for a wireless local area network (WLAN) communication system is being lively progressed under the IEEE (Institute of Electrical and Electronics Engineers) 802.11 standard. Moreover, research activities for the IEEE 802.11 standard that does not require cabling between access points (APs) are being actively carried out.

In wireless communication systems currently used, a data transmission method and a resource allocation method have been proposed to transmit data by efficiently using limited resources, for example, frequency or channel resources, code resources and time slot resources.

In the WLAN communication system prescribed in the IEEE 802.11 standard, a basic service set (BSS) constitutes the basic configuration block of the IEEE 802.11 network. The BSS includes APs which are connected to a wired network through wires and provide communication service and stations (STAs) which receive the communication service from the APs.

Also, in the WLAN communication system, STAs of an independent basic service set (IBSS) can directly communicate with other communication instruments in other communication regions. In the IBSS, respective mobile nodes select channels to be used and implement communication with one another, and at this time, data are transmitted through one wireless channel. Furthermore, in the WLAN communication system, by using different wireless channels between different IBSSs, collision of channels is avoided, and at this time, data are not transmitted through a plurality of channels. That is to say, in the IBSS, data are transmitted using only one wireless channel.

In an infrastructure BBS of the WLAN communication system, the AP selects one channel among a number of usable channels and implements communication with a number of STAs. In particular, in the WLAN communication system, a bandwidth is expanded, for example, from 20 MHz to 40 MHz, to increase a data transmission speed. In this regard, various methods for improving a data processing rate through techniques in a media access control (MAC) device and a physical layer (PHY) have been suggested in the art. Specifically, in the infrastructure BBS, while the AP adopts a multi-input multi-output (MIMO) scheme as a method for increasing a data transmission speed (that is, a data processing rate), limitations necessarily exist. Thus, a resource allocation method for increasing a data processing rate by efficiently using limited resources is demanded in the art.

### SUMMARY OF THE INVENTION

An embodiment of the present invention is directed to an apparatus and a method for allocating resources in a wireless communications system.

Another embodiment of the present invention is directed to an apparatus and a method for allocating resources which can improve a data processing rate by efficiently using limited resources, for example, channels, in a wireless local area network (WLAN).

Another embodiment of the present invention is directed to an apparatus and a method for allocating resources which can adaptively allocate one or more channels in a non-contiguous manner to each of a plurality of access points (APs) in response to a channel allocation request from a system, so that a data transmission speed can be improved using limited channels.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for allocating resources in a wireless communication system includes: a verification unit configured to receive channel information and base station information of a system, verify from the channel information the number of channels capable of being used in the system and bandwidths of the channels, and verify from the base station information the number of base stations and bandwidths of channels requested by the base stations to be allocated; an allocation unit configured to allocate at least one channel of the channels capable of being used to each base station in response to verification by the verification unit; and a generation unit configured to generate allocation information corresponding to channel allocation by the allocation unit and transmit the allocation information to the base stations.

In accordance with another embodiment of the present invention, a method for allocating resources in a wireless communication system includes: receiving channel information and base station information of a system; verifying from the channel information the number of channels capable of being used in the system and bandwidths of the channels, and verifying from the base station information the number of base stations and bandwidths of channels requested by the base stations to be allocated; and allocating at least one channel of the channels capable of being used to each base station in response to verification.

### BRIEF DESCRIPTION OF THE DRAWINGS

FIG. 1 is a view schematically showing the configuration of an apparatus for allocating resources in a wireless communication system in accordance with in embodiment of the present invention.

FIG. 2 is a view schematically showing resource allocating operation of a scheduler in the wireless communication system in accordance with the embodiment of the present invention.

FIGS. 3 to 5 are views showing examples of channel allocation implemented by the scheduler in the wireless communication system in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention. The drawings are not necessarily to scale and in some instances, proportions may have been exaggerated in order to clearly illustrate features of the embodiments.

The present invention discloses an apparatus and a method for allocating resources in a wireless communication system, for example, in the IEEE (Institute of Electrical and Electronics Engineers) 802.11 (for example, the IEEE 802.11a/b) system as a broadband wireless access (BWA) communication system. In the following embodiments of the present invention, the IEEE 802.11a/b system being a wireless local area network (WLAN) communication system will be exemplified as the wireless communication system, for the sake of convenience in explanation. However, it is to be appreciated that the apparatus and method for allocating resources according to the present invention can also be applied to other communication systems.

The present invention suggests an apparatus and a method which adaptively allocate a plurality of channels capable of being used in a wireless communication system to a plurality of base stations (BSs) or access points (APs) in response to a channel allocation request from the system. In this connection, the embodiments of the present invention suggest an apparatus and a method which allocate resources in such a way as to allow one BS or AP to use at least one channel in the IEEE 802.11b system capable of using three wireless channels and the IEEE 802.11a system capable of using twelve wireless channels, so as to increase a data transmission speed.

In the following embodiments of the present invention, as a way of improving a data transmission speed in the IEEE 802.11a/b system, specifically, in the IEEE 802.11a system capable of using an increased number of wireless channels, the bandwidths of data transmission channels are increased or channels are adaptively allocated to a plurality of APs so that a plurality of channels can be simultaneously used. Under situations where a plurality of channels exist, a system, such as a WLAN communication system, requiring a broad band is difficult to secure a plurality of channels having contiguous frequencies. In this connection, in the embodiments of the present invention, by allocating a plurality of non-contiguous channels to APs, a data transmission speed between the APs and stations (STAs) which receive communication service from the APs can be improved.

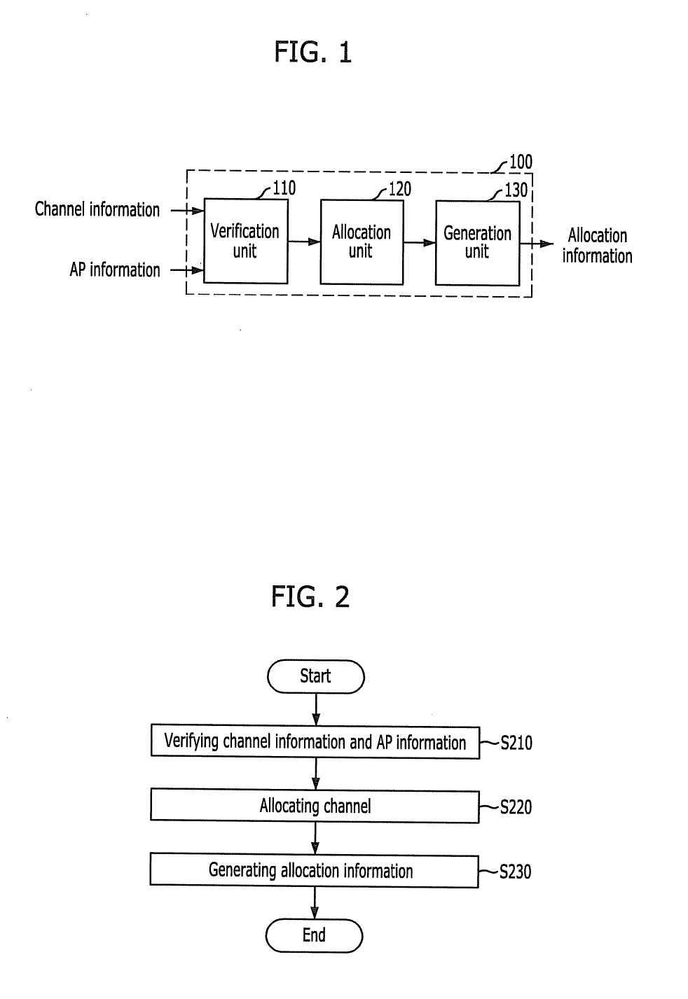

Moreover, in the embodiments of the present invention, in a wireless communication system capable of using an N number of channels, channels are managed by being adaptively allocated to respective BSs or APs in conformity with the number of BSs or APs included in the wireless communication system and the bandwidths of channels which are requested by the BSs or APs to be allocated, and due to this fact, data transmission speeds of the BSs or APs can be maximized. The bandwidths of the respective channels allocated to the BSs or APs may be different from one another. For example, channel allocation can be implemented in a state in which a 20 MHz band and a 40 MHz band are mixed, and one BS or AP is allocated with and uses at least one channel. An apparatus for allocating resources in a wireless communication system in accordance with an embodiment of the present invention will be described below in detail with reference to FIG. 1.

FIG. 1 is a view schematically showing the configuration of an apparatus for allocating resources in,a wireless communication system in accordance with an embodiment of the present invention. FIG. 1 shows a scheduler which performs a resource allocating function in a wireless communication system. The scheduler may exist in the BSs or APs which are included in the wireless communication system or in an upper layer of the BSs or APs. Hereafter, for the sake of convenience in explanation, it is assumed that the scheduler exists in the upper layer of the APs which are included in the wireless communication system. The explanation will be mainly given with respect to the APs of the WLAN system.

Referring to FIG. 1, a scheduler 100 includes a verification unit 110 which verifies the information of resources (that is, channel information) capable of being used by the wireless communication system and the information regarding the APs (that is, AP information) included in the wireless communication system, an allocation unit 120 which adaptively allocates at least one channel to each AP in conformity with the channel information and the AP information verified by the verification unit 110, and a generation unit 130 which generates allocation information in correspondence to the channel allocation by the allocation unit 120 and transmits the allocation information to each AP. The generation unit 130 can generate MAP information as the allocation information.

The verification unit 110 verifies the number of channels capable of being used in the wireless communication system and the bandwidths of the channels (for example, three channels of the IEEE 802.11b system and twelve channels of the IEEE 802.11a system), from channel information, and verifies the number of APs which are allocated with and use the verified channels and the bandwidths of the channels which are requested by the APs to be allocated, from AP information. Here, the channel information and the AP information are received from a server which administrates and controls the wireless communication system.

The allocation unit 120 adaptively allocates at least one of the usable channels capable of being allocated, in conformity with the number of APs and the bandwidths of the channels requested by the APs to be allocated. At this time, the allocation unit 120 allocates one or more channels having contiguous or non-contiguous frequencies among the plurality of usable channels to one AP, or allocates one or more patterned or optional (that is, random) channels to one AP. Furthermore, the allocation unit 120 can group a plurality of usable channels into a pair or a predetermined number and then allocate one or more patterned or random channels to one AP.

At this time, the allocation unit 120 can bind together a plurality of channels having a specific bandwidth as one sub-channel group and allocate appropriate sub-channel groups to the respective APs. Here, the allocation unit 120 can combine the above-described cases depending upon the number and bandwidths of usable channels, the number of APs and the bandwidths of the channels requested to be allocated, and adaptively allocate at least one channel to each AP. While the bandwidths of the channels allocated to the respective APs have the same size, it is preferred that the bandwidths of the channels have different sizes depending upon channel situations and the preferences of the APs with respect to the respective channels. A method for allocating resources in a wireless communication system in accordance with another embodiment of the present invention will be described below in detail with reference to FIG. 2.

FIG. 2 is a view schematically showing resource allocating operation of a scheduler in the wireless communication system in accordance with the embodiment of the present invention.

Referring to FIG. 2, at a step S210, the scheduler verifies channel information as information of resources capable of being used by the wireless communication system and AP information as information of APs included in the wireless communication system. Here, the number and bandwidths of channels capable of being used in the wireless communication system are verified through the channel information, and the number of APs which are allocated with and use the verified channels and the bandwidths of the channels requested by the APs to be allocated are verified through the AP information.

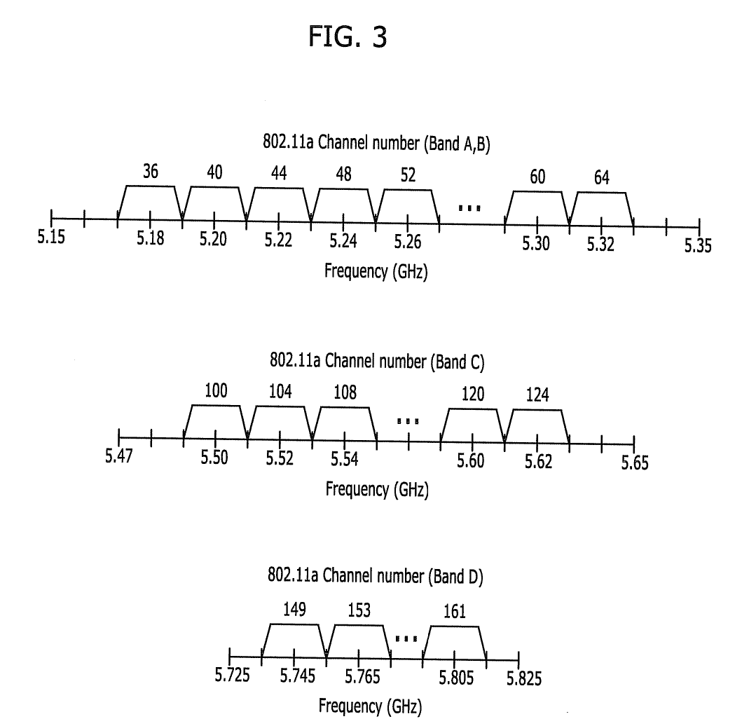

At a step S220, the scheduler adaptively allocates at least one channel to each AP in correspondence to the verified channel information and AP information. Here, at least one channel of the usable channels capable of being allocated is adaptively allocated in correspondence to the number of the APs and the bandwidths of the channels requested by the APs to be allocated. Since the channel allocation will be described in detail with reference to FIGS. 3 through 5, detailed description thereof will be omitted herein.

At a step S230, the scheduler generates allocation information corresponding to the channel allocation and transmits the allocation information to the APs. Hereafter, the channel allocation in the wireless communication system in accordance with the embodiment of the present invention will be described in detail with reference to FIGS. 3 through 5.

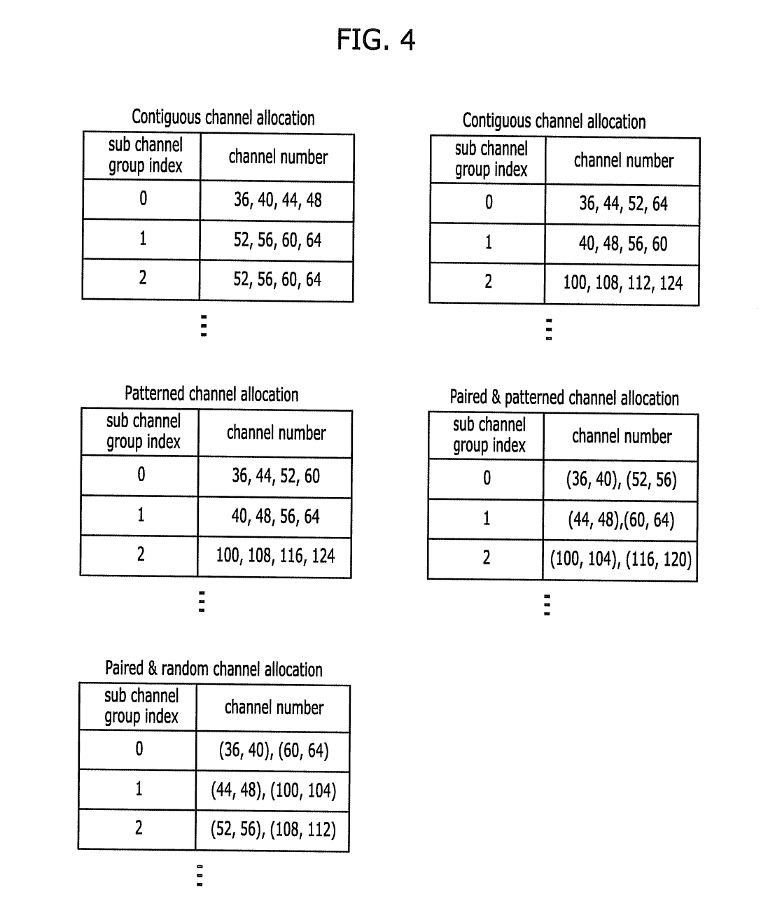

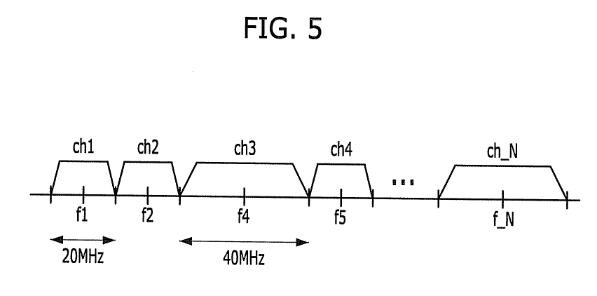

FIGS. 3 to 5 are views showing examples of channel allocation implemented by the scheduler in the wireless communication system in accordance with the embodiment of the present invention. FIG. 3 is of views which respectively show channels capable of being used in the IEEE 802.11a system in wireless channel bands A, B, C and D. FIG. 4 shows an exemplary channel allocation in the case where one AP simultaneously uses a plurality of channels among all the channels capable of being used by the IEEE 802.11a system (that is, where channels requested by one AP to be allocated comprise the plurality of channels). FIG. 5 shows an example in which channel allocation is implemented such that the AP can use a plurality of channels having different bandwidths, in the case where channels having different bandwidths exist in the channels capable of being used by the IEEE 802.11a system.

As shown in FIG. 3, the scheduler of the IEEE 802.11a system allocates to the APs the usable channels among a plurality of channels existing in the respective wireless channel bands so that data can be transmitted and received. For example, when a channel number 40 is allocated to one AP and communication between the AP and STAs is implemented (that is, data are transmitted and received), a channel having a frequency belonging to a different bandwidth from that of the AP is allocated to an AP which adjoins the AP, so as to avoid mutual interference. At this time, in order to improve a data transmission speed, a channel having a bandwidth of 40 MHz can be allocated so that data can be transmitted and received.

Also, as shown in FIG. 4, when implementing channel allocation by combining the aforementioned cases (such 4s contiguous channel allocation, random channel allocation, patterned channel allocation, paired and patterned channel allocation, and paired and random channel allocation), a plurality of channel numbers are allocated to one AP so that communication is effected between the AP and STAs. While channels having a bandwidth of 20 MHz are illustrated in FIG. 4, channel allocation can be implemented in the same manner even when a plurality of channels having different bandwidths exist as shown in FIG. 5 so that communication can be implemented. In addition, the scheduler can bind together a plurality of channels having a specific bandwidth as one sub-channel group and allocate appropriate sub-channel groups to the respective APs so that communication can be implemented between the AP and the STAs.

In addition, as shown in FIG. 5, the scheduler can allocate channels having frequencies belonging to different bandwidths (for example, a channel having a bandwidth of 20 MHz, a channel having a bandwidth of 40 MHz, etc.) to one AP so that communication can be implemented between the AP and STAs.

As is apparent from the above description, in the present invention, one or more channels among channels usable in a wireless communication system are adaptively allocated to each of a plurality of access points (APs) in a non-contiguous manner, so that the limited channels can be efficiently used and a data transmission speed (a data processing rate) can be increased using the limited channels, whereby the performance of the system can be maximized.

While the present invention has been described with respect to the specific embodiments, it will be apparent to those skilled in the art that various changes and modifications may be made without departing from the spirit and scope of the invention as defined in the following claims.

What is claimed is:

1. An apparatus for allocating resources in a wireless communication system, comprising:
a verification unit configured to receive channel information and base station information of a system, verify from the channel information the number of channels capable of being used in the system and bandwidths of the channels, and verify from the base station information the number of base stations and bandwidths of channels requested by the base stations to be allocated;
an allocation unit configured to allocate at least one channel of the channels capable of being used to each base station in response to verification by the verification unit; and
a generation unit configured to generate allocation information corresponding to channel allocation by the allocation unit and transmit the allocation information to the base stations.

2. The apparatus of claim 1, wherein the allocation unit binds together a plurality of channels having a specific bandwidth among the channels capable of being used, as one sub-channel group, and allocates the sub-channel group to each base station.

3. The apparatus of claim 1, wherein the allocation unit allocates a plurality of contiguous channels among the channels capable of being used, to each base station according to a pattern specified in advance or in a random manner.

4. The apparatus of claim 1, wherein the allocation unit allocates a plurality of non-contiguous channels among the channels capable of being used, to each base station according to a pattern specified in advance or in a random manner.

5. The apparatus of claim 1, wherein the allocation unit binds optional two contiguous or non-contiguous channels among the channels capable of being used, as paired channels, and allocates the paired channels to each base station according to a pattern specified in advance.

6. The apparatus of claim 1, wherein the allocation unit binds optional two contiguous or non-contiguous channels among the channels capable of being used, as paired channels, and allocates the paired channels to each base station in a random manner.

7. The apparatus of claim 1, wherein at least two channels allocated to the base station have the same bandwidth.

8. The apparatus of claim 1, wherein at least two channels allocated to the base station have different bandwidths.

9. A method for allocating resources in a wireless communication system, comprising:
receiving channel information and base station information of a system;
verifying from the channel information the number of channels capable of being used in the system and bandwidths of the channels, and verifying from the base station information the number of base stations and bandwidths of channels requested by the base stations to be allocated; and
allocating at least one channel of the channels capable of being used to each base station in response to verification.

10. The method of claim 9, wherein, in said allocating at least one channel of the channels capable of being used to each base station in response to verification,
a plurality of channels having a specific bandwidth among the channels capable of being used are bound together as one sub-channel group, and the sub-channel group is allocated to each base station.

11. The method of claim 9, wherein, in said allocating at least one channel of the channels capable of being used to each base station in response to verification,
a plurality of contiguous channels among the channels capable of being used are allocated to each base station according to a pattern specified in advance or in a random manner.

12. The method of claim 9, wherein, in said allocating at least one channel of the channels capable of being used to each base station in response to verification,
a plurality of non-contiguous channels among the channels capable of being used are allocated to each base station according to a pattern specified in advance or in a random manner.

13. The method of claim 9, wherein, in said allocating at least one channel of the channels capable of being used to each base station in response to verification,
optional two contiguous or non-contiguous channels among the channels capable of being used are bound as paired channels, and the paired channels are allocated to each base station according to a pattern specified in advance.

14. The method of claim 9, wherein, in said allocating at least one channel of the channels capable of being used to each base station in response to verification,
optional two contiguous or non-contiguous channels among the channels capable of being used are bound as paired channels, and the paired channels are allocated to each base station in a random manner.

15. The method of claim 9, wherein at least two channels allocated to the base station have the same bandwidth.

16. The method of claim 1, wherein at least two channels allocated to the base station have different bandwidths.
